(19) United States
(12) Patent Application Publication
(10) Pub. No.: US 2014/0188507 A1
(43) Pub. Date: Jul. 3, 2014

(54) LIFESTYLE PROGRESSION MODELS FOR USE IN PREVENTATIVE CARE

(71) Applicants: INTERNATIONAL BUSINESS MACHINES CORPORATION, Armonk, NY (US); INDUSTRIAL TECHNOLOGY RESEARCH INSTITUTE, Hsinchu (TW)

(72) Inventors: Matthew Chen, Hsinchu (TW); Christina CHUNG, Taipei (TW); Rick HUANG, Taipei (TW); June-Ray LIN, Taipei (TW); Ya-Fan YEH, Taipei (TW); Xinxin ZHU, Yorktown Heights, NY (US)

(73) Assignees: Industrial Technology Research Institute, Hsinchu (TW); International Business Machines Corporation, Armonk, NY (US)

(21) Appl. No.: 13/729,305

(22) Filed: Dec. 28, 2012

(51) Int. Cl. G06F 19/00; G06Q 50/24

(52) U.S. Cl. CPC G06F 19/3431; G06Q 50/24
USPC 705/3

(57) ABSTRACT

A method for generating a lifestyle progression (LSP) plan for a patient subject includes collecting patient data including a list of exercise activities performed over a plurality of non-overlapping periods for a plurality of patients and patient health records. The collected patient data is clustered into related groups using k-mean clustering. An

LSP model for each cluster is created by averaging the exercise activities performed and respective period durations. Patient data for a patient subject including patient health records is received. A vector is calculated for the received patient data. A shortest distance between the calculated vector for the received patient data and vectors calculated for each LSP model is found. An LSP is built for the patient subject bases on the LSP model with the shortest distance to the calculated vector for the received patient data.

### TECHNICAL FIELD

The present disclosure relates to progression models and, more specifically, to lifestyle progression models for use in preventative care.

### DISCUSSION OF THE RELATED ART

Modern times have brought many advances in the understanding and treatment of various ailments. It is now well understood that living a healthy lifestyle involving proper nutrition, sufficient activity, and avoidance of exposure potentially harmful substances is key, not only for improving overall health, but also to significantly reduce risk factors for acquiring particular diseases.

One aspect of maintaining a healthy lifestyle that is of particular significance is the maintenance of a healthy body weight. Obesity has been linked to many diseases such as diabetes, heart disease, cancer, infertility, and back pain.

However, despite this understanding, assuring patient compliance with recommended lifestyle changes remains a difficult prospect that has received comparatively little technological attention.

One important aspect to implementing a healthful lifestyle is to form positive habits. Positive habits may involve proper diet, exercise and avoidance of unhealthy practices such as smoking. While prior to forming habits, compliance with a recommended healthful lifestyle may take persistent effort, once positive habits have been established, a healthful lifestyle may become easier to maintain and more likely to endure.

However, despite understanding that positive habit formation is an important element to successfully adopting a healthful lifestyle, there is still a significant need for approaches to successfully form positive habits.

### SUMMARY

A method for generating a lifestyle progression (LSP) plan for a patient subject, includes collecting patient data including a list of exercise activities performed over a plurality of non-overlapping periods for a plurality of patients. The collected patient data is clustered into a first plurality of groups according to similarities in the exercise activities performed. The patient data that has been clustered into the first plurality of groups is sub-clustered into a second plurality of groups according to the exercise activities performed within each of the non-overlapping periods. The patient data that has been clustered into the first and second plurality of groups is sub-clustered into a first path group and a second path group according to a duration of each of the non-overlapping periods wherein the first path group comprises patient data having relatively short period durations and the second path group comprises patient data having a relatively long period duration. An LSP model is created for each sub-cluster by averaging the exercise activities performed and the period durations. Patient data for a patient subject is received. A closest sub-cluster is determined for the received patient data from among all sub-clusters. The LSP model for the closes sub-cluster is assigned as an LSP for the patient subject.

The list of exercise activities performed over the plurality of non-overlapping periods for the plurality of patients may include training data for assigning the LSP model for the closes sub-cluster as an LSP for the patient subject. The patient data may further include, for each listed exercise activity, a frequency for which the exercise activity has been performed over a specified period of time. Clustering the collected patient data into a first plurality of groups may include performing k-mean clustering. The k-mean clustering is performed with k equal to 5 or 7.

Clustering the collected patient data into the first plurality of groups according to similarities in the exercise activities performed may further include clustering the collected patient data by fitness tests, blood tests, or psychological tests.

Sub-clustering the patient data that has been clustered into the first plurality of groups into a second plurality of groups may include performing k-mean clustering.

Prior to sub-clustering the patient data that has been clustered into the first and second plurality of groups into a first path group and a second path group, average state models may be generated for each sub-cluster and the average state models are used to create the LSP model for each sub-cluster.

Sub-clustering the patient data that has been clustered into the first and second plurality of groups into a first path group and a second path group may include performing k-mean clustering, where k=2.

Creating an LSP model for each sub-cluster by averaging the exercise activities performed and the period durations may include generating a set of rules for assigning an LSP to patients.

The patient data for the patient subject may include fitness tests, blood tests, or psychological tests.

Assigning the LSP model for the closes sub-cluster as an LSP for the patient subject may include applying a set of rules generated while creating an LSP model for each sub-cluster by averaging the exercise activities performed and the period durations.

Determining a closest sub-cluster for the received patient data from among all sub-clusters may include calculating a vector representing the received patient data for a patient subject and calculating a distance between the vector and vectors for each of the LSP models.

A method for generating a lifestyle progression (LSP) plan for a patient subject, includes collecting patient data including a list of exercise activities performed over a plurality of non-overlapping periods for a plurality of patients and patient health records. The collected patient data is clustered into related groups using k-mean clustering. An LSP model for each cluster is created by averaging the exercise activities performed and respective period durations. Patient data for a patient subject including patient health records is received. A vector is calculated for the received patient data. A shortest distance between the calculated vector for the received patient data and vectors calculated for each LSP model is found. An LSP is built for the patient subject bases on the LSP model with the shortest distance to the calculated vector for the received patient data.

The clustering of the collected patient data may be performed based on the list of exercise activities performed or the patient health records.

The vector for the received patient data may be calculated based on the patient health records thereof.

A computer program product for generating a lifestyle progression (LSP) plan for a patient subject includes a computer readable storage medium having program code embodied therewith. The program code is readable/executable by a computer to collect patient data including a list of exercise activities performed over a plurality of non-overlapping periods for a plurality of patients and patient health records. The collected patient data is clustered into related groups using k-mean clustering. An LSP model is created for each cluster by averaging the exercise activities performed and respective period durations. Patient data for a patient subject including patient health records is received. A vector is calculated for the received patient data. A shortest distance between the calculated vector for the received patient data and vectors calculated for each LSP model is calculated. An LSP is built for the patient subject bases on the LSP model with the shortest distance to the calculated vector for the received patient data.

The clustering of the collected patient data may be performed based on the list of exercise activities performed or the patient health records. The vector for the received patient data may be calculated based on the patient health records thereof.

The patient health records may include fitness tests, blood tests, or psychological tests.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a conceptual diagram illustrating various steps and apparatus used in providing lifestyle progression models in accordance with exemplary embodiments of the present invention;

FIG. 2 is a flow chart illustrating an approach for generating a LSP plan in accordance with exemplary embodiments of the present invention; and

FIG. 3 shows an example of a computer system capable of implementing the method and apparatus according to embodiments of the present disclosure.

### DETAILED DESCRIPTION OF THE DRAWINGS

In describing exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Exemplary embodiments of the present invention endeavor to provide various systems and methods for facilitating the adoption of positive habits that may contribute to a healthful lifestyle. These habits may include proper nutrition, activity, and avoidance of potentially harmful activities such as smoking. In particular, exemplary embodiments of the present invention seek to determine a proper length of time needed to successfully establish positive habits for a particular patient so that assistance may be provided for at least this length of time. By providing assistance for the time needed to establish a positive habit, lifestyle changes may be more successful and enduring.

Exemplary embodiments of the present invention may be implemented along with a lifestyle progression (LSP) plan, in which an individualized path is provided to guide a given patient from one state to another and successfully modify patient lifestyle regarding exercise, diet and behavior. Each state represents a particular stage in the patient's progression towards a healthful lifestyle. Each new state may expose the patient to a new set of goals that are to be met. As different states of an LSP may involve different guidelines, being able to successfully tailor the LSP plan to the particular patient may involve knowing how long each state should last for so that assistance may be provided accordingly. In particular, exemplary embodiments of the present invention may estimate a duration of a time required to achieve a state positive habit formation in which the new goals of that state have formed as a habit and thereafter, the patient may be moved to the next state. Accordingly, customized LSP plans may be automatically generated and may be provided on a per-patient basis.

As habit formation comprises a change in behavior, it may be difficult to objectively determine when the habits for each state have been successfully formed and accordingly, proper timing may be particularly important.

The customized LSP may be automatically generated from a flexible model which includes parameters that may be customized for the particular patient. Customization may include a duration for each state, addition or deletion of states, and changes to a progression path.

For example, a first state may include drinking 2000 cc of water per day, burning 400 calories per day, eating only whole-grain food, etc. This first state may be continued until the habit has been formed. The description of the states may be automatically customized for the patient based on medical record data and/or a physician or other medical practitioner may generate/modify the states. This description information may be electronically communicated to the patient, for example, by email and/or be printed out and handed to the patient. State information may thereafter be automatically customized and transmitted to the patient or the state information may be automatically customized and transmitted to the healthcare practitioner who may work with the patient to implement the LSP.

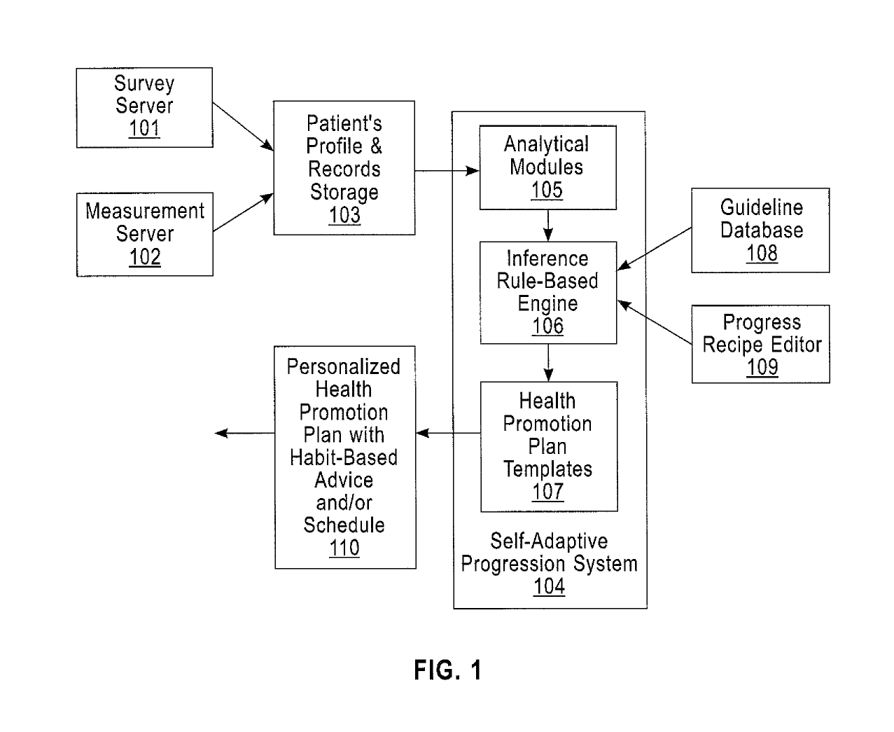

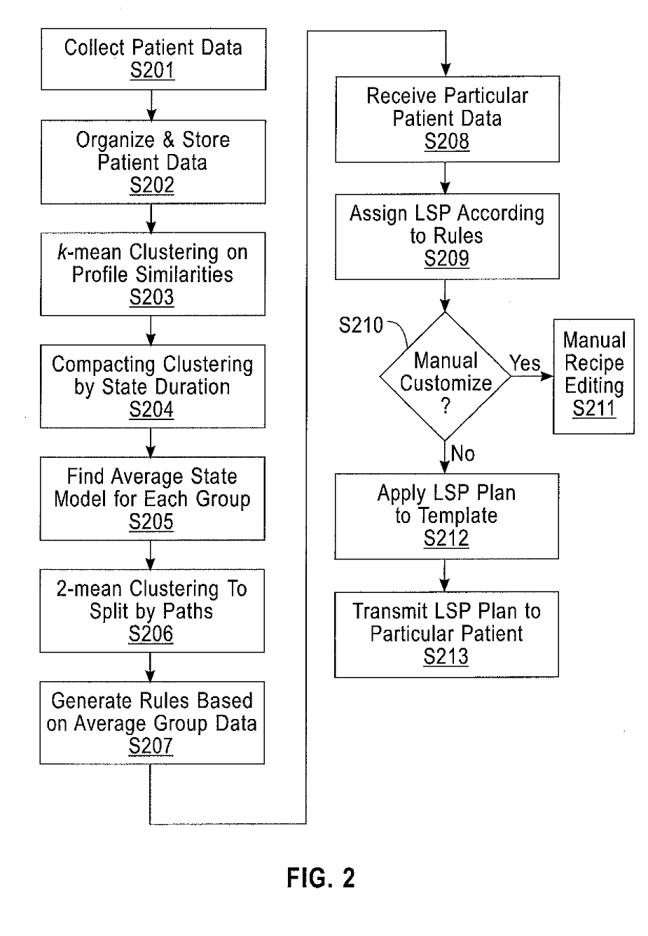

FIG. 1 is a conceptual diagram illustrating various steps and apparatus used in providing lifestyle progression models in accordance with exemplary embodiments of the present invention. FIG. 2 is a flow chart illustrating an approach for generating a LSP plan in accordance with exemplary embodiments of the present invention.

First, patent data may be collected (Step S201), for example, through a survey server 101 and/or through a measurement server 102. The patient data may pertain to a large plurality of patients. Collection may either be conducted as the data is generated or it may involve the transfer of data from existing healthcare databases.

The survey server 101 may be accessed by the patient through a portal, for example, a web browser or a mobile phone application, and the patient may be guided through providing desired information pertaining to the patient's activities, food intake and other lifestyle attributes. The measurement server 102 may receive data directly from one or more diagnostic devices and/or from healthcare provider diagnoses, notes, etc. Measurement server 102 data may include patient physical and/or psychiatric health information. This information may then be sent to a patient's profiles and records storage device 103 where it may be organized and stored (Step S202).

There may be multiple sets of survey servers 101 and/or measurement servers 102. For example, there may be multiple hospitals that collect patient data in the manner described herein and each hospital may have its own measurement server 102. While it may be possible for multiple hospitals to maintain independent survey servers 101, it is also possible that many hospitals share a single survey server 101 as it may be made accessible over the Internet. Similarly, all survey servers 101 and measurement servers 102 may feed data to a single patient's profiles and records storage device 103. While this patient's profiles and records storage device 103 may be located at only one location, it may alternatively be replicated at multiple locations, for example, at each hospital making use of the system described herein. However, by combining information from multiple measurement servers 102, the patient's profiles and records storage device 103 may obtain a broader base of data from which to derive inferences about stage duration.

The patient's profiles and records storage device 103 may store, among other patient data, activity records, which may be compliance results, for example, in the form of a checklist, identifying which prescribed exercises were conducted, which diet elements were successfully implemented, and/or which prescribed behaviors were conducted. This activity data may be entered manually by the particular patients using the survey server 101.

The patient data may then be sent from the patient's profiles and records storage device 103 to a self-adaptive progression system 104 which may be responsible for generating the lifestyle progression (LSF) plan.

In particular, analytical modules 105 within the patient's profiles and records storage device 103 may use the stored patient data as training data to devise one or more rules for creating customized LSP plans. For example, the analytical model 105 may cluster similar patients using a k-mean algorithm, to identify k groups based on profile similarity (Step S203). A state of transition model may be created for each patient in a specific group. The state transition model may describe, for each particular patient, which exercises, diet restrictions, and behaviors were followed within each state and may describe how long each state endures for.

The transition states themselves, including the state transition model information, may then be compacted by clustering the transition states using a k-mean algorithm so that the states are grouped together by non-overlapping time periods (Step S204). For example, the first cluster may consist of activities, dietary restrictions, and behaviors followed during weeks 1-20 of the particular LSP, the second cluster may consist of activities, dietary restrictions, and behaviors followed during weeks 21-40 of the particular LSP, etc. Here, k may equal 5 or 7, which is to say, the transition states may be divided into 5 or 7 time periods. These time periods may form the basis of states for the LSP model that will be recommended.

Then, for each group, an average/best state model may be found (Step S205). The average/best state model may be a state model created from the average of each of the other states within the group. For example, the average/best state model may include the most frequently followed exercises, dietary restrictions, and behaviors and may establish a frequency or amount (such as repetitions of the exercise or quantity/calories of diet) that is set as the average of such values within the group. The average/best state may also use the average length of time spent within the given state. This average/best state may be limited to patients who had exhibited successful outcomes, for example, the patient was able to continue to the next state and/or to complete all states successfully.

Clustering may thereafter be performed again to split the data into two groups based on duration of each state (Step 5206). In this way, the data may be arranged with the first group of the lower durations representing a “short path” and the second group of the higher durations representing a “relaxed path.” By dividing the data in this way, the resulting customized LSP plans may incorporate a flexibility to assign the patient to either a short path or a relaxed path depending on the patient's need.

The determination as whether a particular patient will be assigned to the short path or the relaxed path may be dependent upon whether the particular patient's patient data more closely matches the patient data of the short path group or that of the relaxed path group. While any patient data may be considered for this purpose, a particular emphasis may be placed on matching diagnosis data and physical and/or psychiatric health information.

The analytical modules 105 may accordingly generate a set of rules from the clustered data (Step S207). For example, a set of rules for determining whether a particular patient is to follow the short path or the relaxed path may be generated. These rules may be sent directly to an inference rule-based engine 106 or may be stored in a guideline database 108 for subsequent retrieval by the inference rule-based engine 106.

These rules may include a calculation of central vectors within each clustered group. The central vector may represent the average data for patients within that cluster. The rules may therefore include central vectors for each cluster and instructions to calculate a vector for particular patient data and to calculate a vector distance between the vector of the particular patient and each central vector of each cluster to find a shortest distance and create a LSP plan for the particular patient based on the LSP model of the group of the shortest vector.

The inference rule-based engine 106 may be responsible for customizing a particular patient's LSP plan based on the rules of the guideline database 108. However, manual customization may not be required in accordance with exemplary embodiments of the present invention. Rather, data from a particular patient may be received (Step S208), a vector determined therefrom, and a shortest vector distance to a central vector of a cluster identified, as described above. An LSP plan may thereafter be assigned to the particular patient based on the LSP model derived from the data of the shortest-vector distance cluster (Step S209).

However, where manual customization is desired (Yes, Step S210), a progress recipe editor 109 may be used by a healthcare provider to adjust the assigned LSP plan (Step S211).

In either event, the assigned LSP plan may be applied to a health promotion plan template 107 to arrange the data into a proper LSP plan (Step S212). The personalized health promotion plan with habit-based advice and/or schedule 110 may then be transmitted or otherwise presented to the patient (Step S213).

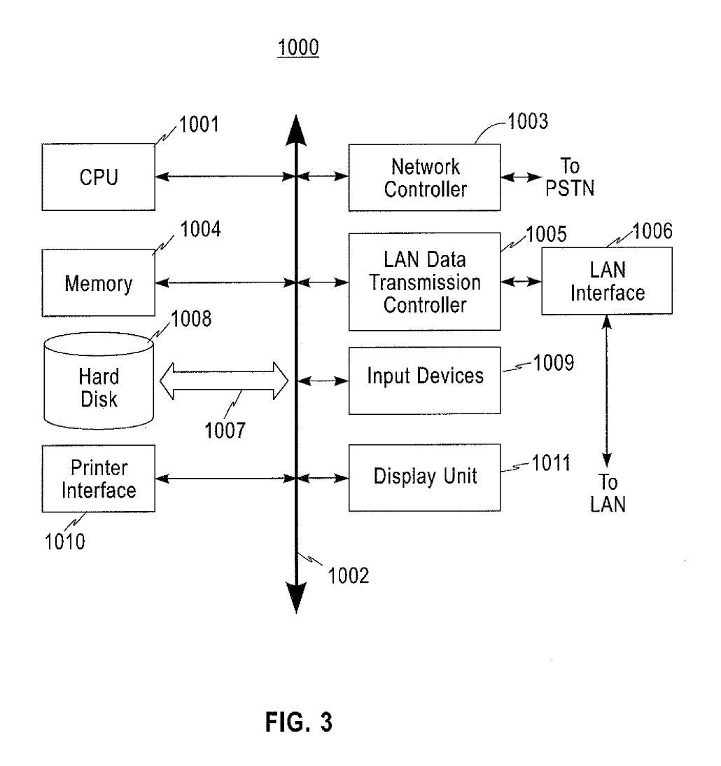

FIG. 3 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Exemplary embodiments described herein are illustrative, and many variations can be introduced without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for generating a lifestyle progression (LSP) plan for a patient subject, comprising:
collecting patient data including a list of exercise activities performed over a plurality of non-overlapping periods for a plurality of patients;
clustering the collected patient data into a first plurality of groups according to similarities in the exercise activities performed;
sub-clustering the patient data that has been clustered into the first plurality of groups into a second plurality of groups according to the exercise activities performed within each of the non-overlapping periods;
sub-clustering the patient data that has been clustered into the first and second plurality of groups into a first path group and a second path group according to a duration of each of the non-overlapping periods wherein the first path group comprises patient data having relatively short period durations and the second path group comprises patient data having a relatively long period duration;
creating an LSP model for each sub-cluster by averaging the exercise activities performed and the period durations;
receiving patient data for a patient subject;
determining a closest sub-cluster for the received patient data from among all sub-clusters; and
assigning the LSP model for the closes sub-cluster as an LSP for the patient subject.

2. The method of claim 1, wherein the list of exercise activities performed over the plurality of non-overlapping periods for the plurality of patients constitutes training data for assigning the LSP model for the closes sub-cluster as an LSP for the patient subject.

3. The method of claim 1, wherein the patient data further includes, for each listed exercise activity, a frequency for which said exercise activity has been performed over a specified period of time.

4. The method of claim 1, wherein clustering the collected patient data into a first plurality of groups includes performing k-mean clustering.

5. The method of claim 4, wherein the k-mean clustering is performed with k equal to 5 or 7.

6. The method of claim 1, wherein clustering the collected patient data into the first plurality of groups according to similarities in the exercise activities performed further includes clustering the collected patient data by fitness tests, blood tests, or psychological tests.

7. The method of claim 1, wherein sub-clustering the patient data that has been clustered into the first plurality of groups into a second plurality of groups comprises performing k-mean clustering.

8. The method of claim 1, wherein prior to sub-clustering the patient data that has been clustered into the first and second plurality of groups into a first path group and a second path group, average state models are generated for each sub-cluster and the average state models are used to create the LSP model for each sub-cluster.

9. The method of claim 1, wherein sub-clustering the patient data that has been clustered into the first and second plurality of groups into a first path group and a second path group includes performing k-mean clustering, where k=2.

10. The method of claim 1, wherein creating an LSP model for each sub-cluster by averaging the exercise activities performed and the period durations includes generating a set of rules for assigning an LSP to patients.

11. The method of claim 1, wherein the patient data for the patient subject includes fitness tests, blood tests, or psychological tests.

12. The method of claim 1, wherein assigning the LSP model for the closes sub-cluster as an LSP for the patient subject includes applying a set of rules generated while creating an LSP model for each sub-cluster by averaging the exercise activities performed and the period durations.

13. The method of claim 1, wherein determining a closest sub-cluster for the received patient data from among all sub-clusters comprises calculating a vector representing the received patient data for a patient subject and calculating a distance between said vector and vectors for each of the LSP models.

14. A method for generating a lifestyle progression (LSP) plan for a patient subject, comprising:
collecting patient data including a list of exercise activities performed over a plurality of non-overlapping periods for a plurality of patients and patient health records;
clustering the collected patient data into related groups using k-mean clustering;
creating an LSP model for each cluster by averaging the exercise activities performed and respective period durations;
receiving patient data for a patient subject including patient health records;
calculating a vector for the received patient data;
finding a shortest distance between the calculated vector for the received patient data and vectors calculated for each LSP model; and
building an LSP for the patient subject bases on the LSP model with the shortest distance to the calculated vector for the received patient data.

15. The method of claim 14, wherein the clustering of the collected patient data is performed based on the list of exercise activities performed or the patient health records.

16. The method of claim 14, wherein the vector for the received patient data is calculated based on the patient health records thereof.

17. A computer program product for generating a lifestyle progression (LSP) plan for a patient subject, the computer program product comprising a computer readable storage medium having program code embodied therewith, the program code readable/executable by a computer to:
collect patient data including a list of exercise activities performed over a plurality of non-overlapping periods for a plurality of patients and patient health records;
cluster the collected patient data into related groups using k-mean clustering;
create an LSP model for each cluster by averaging the exercise activities performed and respective period durations;
receive patient data for a patient subject including patient health records;
calculate a vector for the received patient data;
find a shortest distance between the calculated vector for the received patient data and vectors calculated for each LSP model; and
build an LSP for the patient subject bases on the LSP model with the shortest distance to the calculated vector for the received patient data.

18. The computer program product of claim 17, wherein the clustering of the collected patient data is performed based on the list of exercise activities performed or the patient health records.

19. The computer program product of claim 17, wherein the vector for the received patient data is calculated based on the patient health records thereof.

20. The computer program product of claim 17, wherein the patient health records include fitness tests, blood tests, or psychological tests.
